(19) United States
(12) Patent Application Publication
(10) Pub. No.: US 2007/0203993 A1
(43) Pub. Date: Aug. 30, 2007

(54) Instant messaging control

(76) Inventors: Yigang Cai, Naperville, IL (US); Shiyan Hua, Lisle, IL (US)

Correspondence Address: Werner Ulrich, 434 Maple Street, Glen Ellyn, IL, 60137-3826, US

(21) Appl. No.: 11/364,782

(22) Filed: Feb. 28, 2006

(51) Int. Cl. G06F 15/16

(52) U.S. Cl. 709/206; 709/228

(57) ABSTRACT

This invention relates to a method and apparatus to control instant message (IM) traffic. A receiver terminal/device provides a filter function to an instant message server. The server checks the filter function to determine whether the receiver is willing to receive a message from a sender terminal/device, and transmits or blocks the message accordingly. The filter function can be modified dynamically, in real time, in response to the needs of the receiver customer. Advantageously, IM traffic can be adapted to emergency conditions.

### TECHNICAL FIELD

This invention relates to a method and apparatus for real time control of instant messaging traffic to an end user by the end user herself/himself using a message filtering menu.

### BACKGROUND OF THE INVENTION

Instant messaging has become a highly popular service. The reasons are not hard to determine. Instant messaging allows the communicators to communicate with text message in parallel with whatever they are doing for voice, or video communication. It is especially popular among younger people who frequently communicate while they are actually supposed to be doing something else.

The virtues of instant messaging are also the source of its problems. The people who communicate via instant messaging are not always willing to be interrupted. Accordingly, one of the services provided with most instant messaging systems is the ability to screen calls from a black list of callers or to allow calls only from a predefined list (white list) of callers. However, this rudimentary means for controlling instant messaging traffic does not provide the type of control that a sophisticated and busy user needs.

### SUMMARY OF THE INVENTION

The above problem is substantially alleviated and a contribution is made over the teachings of the prior art in accordance with Applicants' invention wherein the identity of an instant message caller is subjected to extensive screening before an instant message session is established, the screening being controllable in real time by the instant message recipient. The screening includes black list filtering by network realms; by “buddy groups” (i.e., groups of callers who have a high degree of common interest, such as workers on a common project; by limitation on the time and/or number of sessions of instant messaging that the user will accept; a filtering based on the type of message medium (e.g., only text or only text and voice); or a time restriction limiting the number of instant message sessions that will be accepted during particular times (such as during working hours or after working hours). Advantageously, this type of arrangement allows a user to control incoming instant messages by source and by volume; in particular, by allowing the screening to be controllable in real time, the recipient can respond to emergency situations where only messages from particular sources are wanted, even though at other times, a much broader list of sources are acceptable.

In accordance with one feature of Applicants' invention, the filter function of a user can be established in a user profile stored, for example, in an instant message server serving that user. The user can update the filter function by communicating with the instant message server. Advantageously, the user can change the instant message filtering function to respond to different situations such as emergencies requiring a high volume of instant message traffic.

In accordance with one preferred embodiment, the privacy tab in the options field of a tools menu available in an instant message window is enhanced to provide privacy/filtering. The filtering data and rules are stored in the instant message server serving that customer. A new filtering menu is added to the instant message window to allow the end user to specify the various filtering options. The filtering options include the presently available no filtering (i.e., any instant message request will be accepted), filtering to allow only instant messages from members of the white list; filtering to reject any instant messages from members of the black list; filtering to allow messages from a list of network realms, such as individual instant messaging carriers, or to disallow messages from the list of network realms; filtering by limiting the number of instant message sessions, for example, during each hour; filtering by message medium to allow, for example, only data or voice messages; and filtering by time restrictions which can be added to any of the filtering options described above.

### BRIEF DESCRIPTION OF THE DRAWING

FIG. 1 is a block diagram illustrating the operation of Applicants' invention;

FIG. 2 is a flow diagram illustrating the operation of Applicants' invention; and

FIG. 3 is a flow diagram illustrating the process of modifying a customer's filter function.

### DETAILED DESCRIPTION

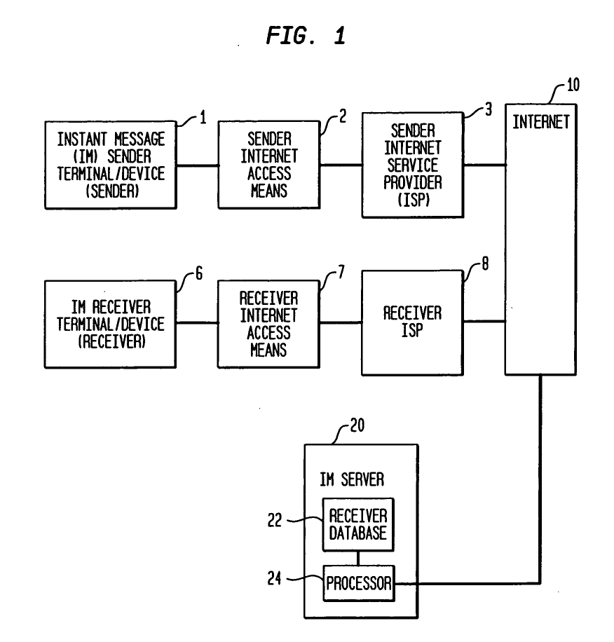

FIG. 1 is a block diagram illustrating the operation of Applicants' invention. IM sender terminal/device (sender) 1 establishes a connection through an IM sender terminal/device access means 2 (which can be a direct line or a connection through public switched telephone and, if the IM sender terminal/device (sender) is using a wireless device, the wireless network) to the sender's Internet service provider (ISP) 3. The ISP sets up a connection over the Internet to an instant message server 20 serving the IM receiver terminal/device 6. The terminal/device can be applied to any network such as wireless, wireline, IP, WiFi, WiMax.

Before establishing the instant message connection session, the instant message server checks whether the IM receiver terminal/device (receiver) is willing to accept the establishment of such a connection. The instant message server has a database 22, accessed by the control processor 24 of the server, for storing screening restrictions for the IM receiver terminal/device. The screening restrictions, a filter function, are filtering information describing restrictions on incoming instant message traffic specified by the IM receiver terminal/device. If the instant message is authorized, i.e., if the screening as controlled by the database allows the instant message to be delivered, then the instant message server 20 controls the establishment of a connection over the Internet 10 to the receiver's Internet service provider 8. The receiver's Internet service provider then establishes a connection via the receiver's Internet access means 7 to the IM receiver terminal/device 6.

If the result of testing the screening indicates that the IM receiver terminal/device is unwilling to accept the establishment of the connection session, i.e., if the instant message session is not authorized, the IM sender terminal/device (sender) will receive a message indicating that the IM receiver terminal/device (receiver) is not willing to accept such a connection session.

Note that with instant messaging it is not necessary to check whether the IM receiver terminal/device (IM receiver) is busy because as long as the IM receiver terminal/device has powered on his/her (device), an instant message indication will appear at the IM receiver terminal/device terminal.

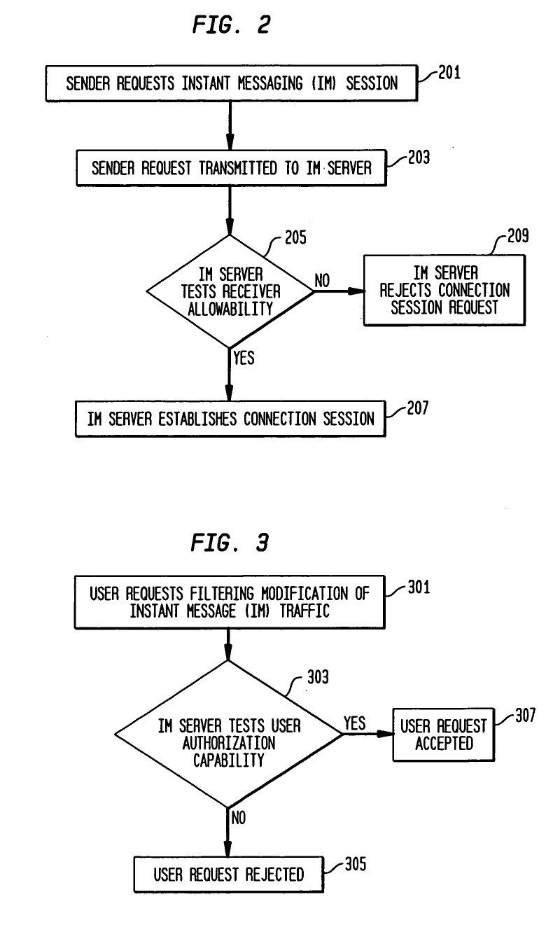

FIG. 2 is a flow diagram illustrating the processing of an instant message session request. The IM sender terminal/device (sender) requests such an instant messaging session (action block 201). This request is transmitted to an instant message server (action block 203). The IM server tests whether the IM receiver terminal/device (receiver) allows IM sessions to be established from the IM sender terminal/device (sender) (test 205). Test 205 checks the IM sender terminal/device's identity against all the filters specified by the IM receiver terminal/device (receiver). These filters include black lists and network realm identities. The filtering also checks that even if instant messages from the IM sender terminal/device (sender) are allowed, whether a maximum number of sessions has been exceeded, whether the medium of the message (e.g., video or voice) is allowed according to the filtering criteria, and whether the time of day and/or day of week restriction is being violated.

If the result of test 205 indicates that there is no violation of a screening restriction, then the instant message session can be established. Otherwise, the caller (sender) receives a message indicating that no instant message connection session can be established at this time. When a change of medium is encountered, such as a change from voice to video, another check is made to see if there is a restriction for the new medium.

FIG. 3 is a flow diagram illustrating the process of modifying the screening information in the customer's user profile as stored in the IM server. The user requests a filtering modification of his/her incoming instant message (IM) traffic (action block 301). The IM server tests whether the user is authorized to make such changes. This check may include a test of a provided personal identification number (PIN) (action block 303). As a result of the test, the user request is either rejected (action block 305) or accepted (action block 307). If the user request is accepted, then the IM server provides a menu to the user and the user specifies the appropriate options and data for responding to the menu. The results of the modification session are then stored in the IM server and the revised filtering function is stored in the user profile.

In accordance with one feature of this invention, the user is allowed to send an emergency instant message. The tool menu of the client software of the user's device allows the user to select the priority of the instant message to be sent out. The priority level can be normal, high, highest, and emergency.

In accordance with one option, any user is allowed to send an emergency instant message. Once the instant message server 20 receives an emergency instant message, it will forward to the receiver without checking the receiver filtering rules.

Alternatively, service providers can set a special rule set to deal with emergency instant messages. For example, 1) a default rule is no filtering against emergency instant messages; or 2) allow the subscribers to set priority level and emergency white list for emergency instant messages; or 3) the service provider's rule will take precedence over subscriber's rules.

The above description is of one preferred embodiment of Applicants' invention. Other embodiments will be apparent to those of ordinary skill in the art. The invention is limited only by the attached claims.

We claim:

1. A method of establishing an instant messaging (IM) session between an IM sender terminal/device (sender) and an IM receiver terminal/device (receiver), comprising the steps of:
providing information for a filter function for said receiver and storing said information in real time;
responsive to a request from said sender to establish a connection to said receiver, testing whether said filter function of said receiver permits instant message sessions from said sender;
if said filter function does not permit an instant message session from said sender to said receiver, blocking said request; and
if said filter function permits an instant message session from said sender to said receiver, establishing such an instant message session between said sender and said receiver.

2. The method of claim 1 wherein a plurality of priority levels can be assigned to instant messages and wherein said filter function can filter differently for different priority levels.

3. The method of claim 2 wherein one of said priority levels is an emergency level and wherein emergency level messages are not blocked.

4. The method of claim 2 wherein one of said priority levels is an emergency level and wherein emergency level messages are blocked only by a rule for a service provider for transmitting said instant messages.

5. The method of claim 1 wherein said filter function comprises a black list of senders whose messages are to be blocked.

6. The method of claim 1 wherein said filter function comprises a white list of senders whose instant message session requests are to be allowed.

7. The method of claim 6 wherein said white list comprises all senders in prescribed network realms.

8. The method of claim 6 wherein said white list comprises all senders in a buddy group.

9. The method of claim 1 wherein said filter function comprises time parameters to limit IM traffic to a receiver during prescribed hours.

10. Apparatus for establishing an instant messaging (IM) session between an IM sender terminal/device (sender) and an IM receiver terminal/device (receiver), comprising:
means for providing information for a filter function for said receiver and storing said information in real time;
means, responsive to a request from said sender to establish a connection to said receiver, for testing whether said filter function of said receiver permits instant message sessions from said sender;
if said filter function does not permit an instant message session from said sender to said receiver, means blocking said request; and
if said filter function permits an instant message session from said sender to said receiver, means for establishing such an instant message session between said sender and said receiver.

11. The apparatus of claim 10 wherein a plurality of priority levels can be assigned to instant messages and wherein said filter function can filter differently for different priority levels.

12. The apparatus of claim 11 wherein one of said priority levels is an emergency level and wherein emergency level messages are not blocked.

13. The apparatus of claim 11 wherein one of said priority levels is an emergency level and wherein emergency level messages are blocked only by a rule for a service provider for transmitting said instant messages.

14. The apparatus of claim 10 wherein said filter function comprises a black list of senders whose messages are to be blocked.

15. The apparatus of claim 10 wherein said filter function comprises a white list of senders whose instant message session requests are to be allowed.

16. The apparatus of claim 15 wherein said white list comprises all senders in prescribed network realms.

17. The apparatus of claim 15 wherein said white list comprises all senders in a buddy group.

18. The apparatus of claim 10 wherein said filter function comprises time parameters to limit IM traffic to a receiver during prescribed hours.
